(19) United States
(12) Patent Application Publication
(10) Pub. No.: US 2020/0136206 A1
(43) Pub. Date: Apr. 30, 2020

(54) LITHIUM-ION POWER BATTERY

(71) Applicant: CHANGSHA JUNENGCHONG NEW ENERGY CO., LTD, Changsha (CN)

(72) Inventor: Bo-Qian Qiu, Changsha (CN)

(21) Appl. No.: 16/727,649

(22) Filed: Dec. 26, 2019

Related U.S. Application Data
(63) Continuation of application No. PCT/CN2018/093109, filed on Jun. 27, 2018.

(30) Foreign Application Priority Data
Jun. 28, 2017 (CN) 201710503309.6
Jun. 28, 2017 (CN) 201710503711.4

(51) Int. Cl. H01M 10/654; H01M 10/617; H01M 10/655; H01M 10/48; H01M 10/0525

(52) U.S. Cl. CPC H01M 10/654; H01M 10/617; H01M 10/655; B23K 2101/36; H01M 10/0525; H01M 2220/20; H01M 10/486

(57) ABSTRACT

A lithium-ion power battery includes a battery cell including positive and negative electrode plates. The positive electrode plate includes a positive current collector and a positive active material layer coated on the positive current collector. The negative electrode plate includes a negative current collector and a negative active material layer coated on the negative current collector. At least one of the positive and negative electrode plates includes a heat conducting and collecting body which is a portion of the current collector not coated by the active material layer. At least two heat conducting and collecting bodies are stacked together to form at least one heat converging path, which allows heat energy to enter or exit from the battery cell. An insulating element is connected to the at least one heat converging path.

### CROSS-REFERENCE TO RELATED APPLICATIONS

This application claims all benefits accruing under 35 U.S.C. § 119 from China Patent Application No. 201710503711.4, filed on Jun. 28, 2017, and China Patent Application No. 201710503309.6, filed on Jun. 28, 2017, in the China National Intellectual Property Administration, the content of which is hereby incorporated by reference. This application is a continuation under 35 U.S.C. § 120 of international patent application PCT/CN2018/093109 filed Jun. 27, 2018.

### FIELD

The subject matter herein generally relates to lithium-ion batteries, and more particularly, to a lithium-ion power battery.

### BACKGROUND

Traffic on the roads brings pressure on the energy crisis and environmental pollution, thus it is urgent to develop and research efficient, clean, and safe new energy vehicles to achieve energy conservation and emission reduction. Lithium-ion batteries have become the best candidates for power systems of the new energy vehicles because of high specific energy, no pollution, and no memory effect. However, the lithium-ion batteries are very sensitive to temperature, and efficient discharge and good performance of the battery pack can be only obtained within a suitable temperature range. At an elevated temperature may cause the lithium-ion battery to age faster and increase its thermal resistances faster. The cycle time becomes less, the service life becomes shorter, and even thermal runaway problems can occur at an elevated operating temperature. However, operating at too low a temperature may lower the conductivity of the electrolyte and the ability to conduct active ions, resulting an increase of the impedance, and a decrease in the capacity of the lithium-ion batteries.

Conventionally, the position of the cell is changed to improve the fluid flow path and increase the heat dissipation. The battery casing may also be improved by replacing the aluminum alloy shell material with the composite of thermoelectric material and aluminum, and by adding a plurality of heat dissipating ribs to the side of the housing. The electrode plate may also be extended into the electrolyte to transmit heat energy to the battery casing through the electrolyte and then to the outside of the battery. Although some heat is dissipated, heat dissipation efficiency is still poor since the heat cannot be directly discharged from the main heat generating component, the electrode plates, to the outside of the battery. Therefore, a new lithium-ion battery is needed.

### BRIEF DESCRIPTION OF THE DRAWINGS

FIG. 1 is a schematic view of a lithium-ion power battery in a first embodiment according to the present disclosure.

FIG. 2 is a schematic view of a battery cell of the lithium-ion power battery of FIG. 1.

FIG. 3 is a cross-sectional view of a battery cell of the lithium-ion power battery of FIG. 1.

FIG. 4 is a cross-sectional view of a battery cell of a lithium-ion power batter in a second embodiment according to the present disclosure.

FIG. 5 is a schematic view of a lithium-ion power battery in a third embodiment according to the present disclosure.

FIG. 6 is a schematic view of a lithium-ion power battery in a fourth embodiment according to the present disclosure.

FIG. 7 is a schematic view of a lithium-ion power battery in a fifth embodiment according to the present disclosure.

FIG. 8 is a schematic view of a lithium-ion power battery in a sixth embodiment according to the present disclosure.

FIG. 9 is a schematic view of a lithium-ion power battery in a seventh embodiment according to the present disclosure.

FIG. 10 is a schematic view of a lithium-ion power battery in an eighth embodiment according to the present disclosure.

FIG. 11 is a schematic view of a lithium-ion power battery in a ninth embodiment according to the present disclosure.

FIG. 12 is a schematic view of a lithium-ion power battery in a tenth embodiment according to the present disclosure.

FIG. 13 is a schematic view of a lithium-ion power battery in an eleventh embodiment according to the present disclosure.

### DETAILED DESCRIPTION

Implementations of the disclosure will now be described, by way of embodiments only, with reference to the drawings.

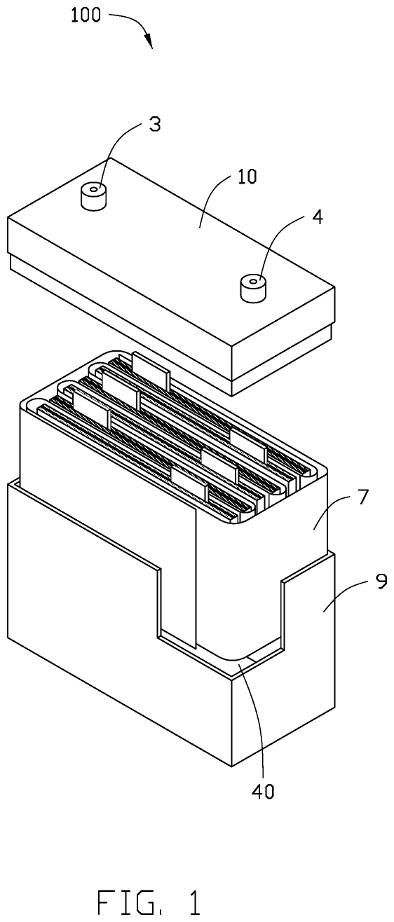

FIGS. 1 to 3 illustrate a first embodiment of a lithium-ion power battery 100 comprising a battery cell 7, a metal casing 9 configured to receive the battery cell 7, an electrolyte 40 injected into the metal casing 9, and a top cover plate 10 fixedly connected to the metal casing 9. The battery cell 7 comprises a positive electrode plate 71, a negative electrode plate 73, and a separator 72 spaced between the positive electrode plate 71 and the negative electrode plate 73. The positive electrode plate 71, the separator 72, and the negative electrode plate 73 are sequentially laminated or wound to form the battery cell 7. The positive electrode plate 71 carries a positive electrode tab 1. The negative electrode plate 73 carries a negative electrode tab 2. The top cover plate 10 carries a positive terminal post 3 which is electrically connected to the positive electrode tab 1, and a negative terminal post 4 which is electrically connected to the negative electrode tab 2.

The negative electrode plate 73 comprises a negative current collector 731 and two negative active material layers 733 which are coated on the front and back sides of the negative current collector 731. The positive electrode plate 71 comprises a positive current collector 711 and two positive active material layers 713 which are coated on the front and back sides of the positive current collector 711. At least one of the positive electrode plate 71 and the negative electrode plate 73 further comprises a heat conducting and collecting body 5. The heat conducting and collecting body 5 is a portion of the positive current collector 711 not coated by the positive active material layer 713 or a portion of the negative current collector 731 not coated by the negative active material layer 733. At least two heat conducting and collecting bodies 5 are stacked together to form at least one heat converging path 11, which is configured to transmit heat energy into or out of the battery cell 7. The heat converging path 11 is stacked with or connected to an insulating element 20 to form an insulating heat converging path assembly (not shown), thus avoiding a short circuit of the heat converging path 11 and concomitant damage.

The heat conducting and collecting body 5 can be integrally formed with the positive electrode plate 71, which simplifies the manufacturing process and increases the manufacturing efficiency. By stacking the heat conducting and collecting bodies 5 to form the heat converging path 11 and heating/cooling the heat converging path 11, the internal temperature of the battery 100 can be increased or decreased, thereby maintaining the internal temperature of the battery 100 at a suitable working temperature, improving a working efficiency of the battery 100, extending a service life of the battery 100, and avoiding concomitant damage.

In at least one embodiment, the heat conducting and collecting bodies 5 overlap with each other. The heat conducting and collecting bodies 5 are connected by welding to form the heat converging path 11. Not only are the heat conducting and collecting bodies 5 securely connected to each other, but weight of the battery 100 is thus reduced and an energy density of the battery 100 can be improved by employing the welding connecting process. The welding can be ultrasonic welding, laser welding, or friction welding. In another embodiment, the heat conducting and collecting bodies 5 can also be connected by bolting or riveting. The separator 72 will not be damaged by employing the bolting or riveting connecting processes.

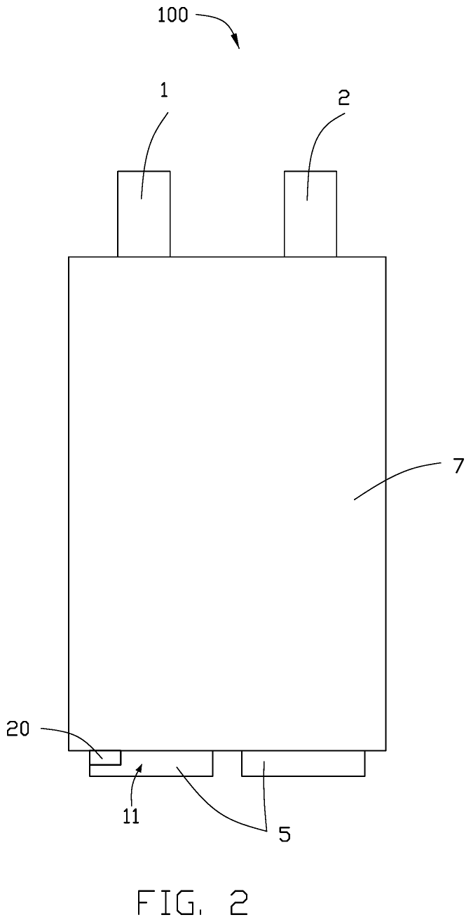

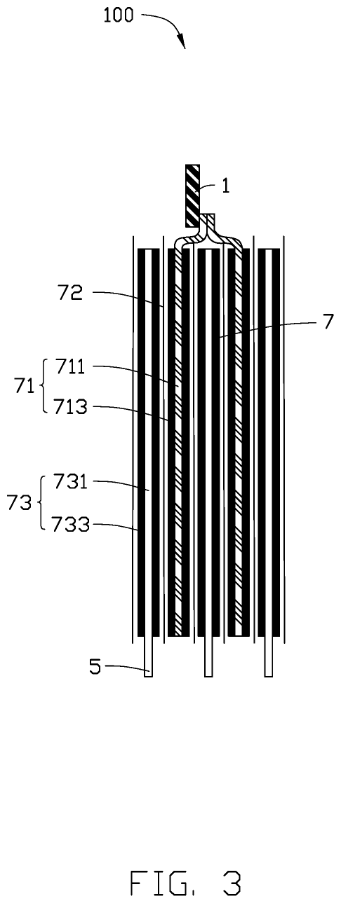

In at least one embodiment, referring to FIG. 1, the positive and negative electrode tabs 1 and 2 are arranged on a same side of the battery 100. The positive and negative electrode plates both carry the heat conducting and collecting body which is arranged on an opposite side of the battery 100. Referring to FIGS. 2 and 3, the heat conducting and collecting body 5 is connected to the negative current collector 731 as an integral unit.

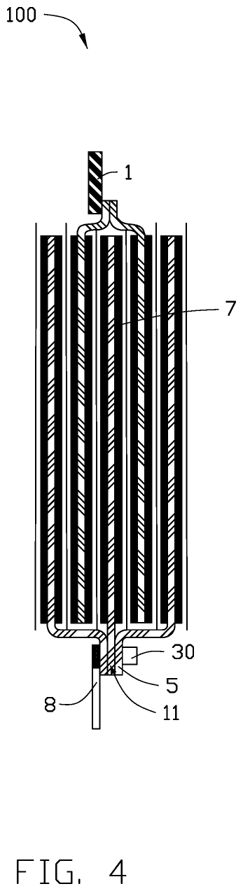

Moreover, referring to FIG. 4, the heat conducting and collecting bodies 5 are bent towards each other. Therefore, the heat absorbed by the heat conducting and collecting bodies 5 is converged, which facilitates heat-dissipation from the battery 100 or heating of the battery 100. The heat conducting and collecting bodies 5 after being bent can be inclined with the positive electrode plate 71 or the negative electrode plate 73 by an angle of 0 degree to 90 degrees. The heat conducting and collecting bodies 5 can be bent toward different directions (for example, the bending direction of a portion of the heat conducting and collecting bodies 5 being opposite to that of the remaining heat conducting and collecting bodies 5). As such, the heat conducting and collecting bodies 5 can be in stable contact with each other. The entirety of the heat conducting and collecting bodies 5 can also be bent toward a single direction, which facilitates the connection of the heat conducting and collecting bodies 5. In other embodiments, portions of the heat conducting and collecting bodies 5 are bent toward a single direction or different directions, and connected to the remaining heat conducting and collecting bodies 5 being straight (unbent).

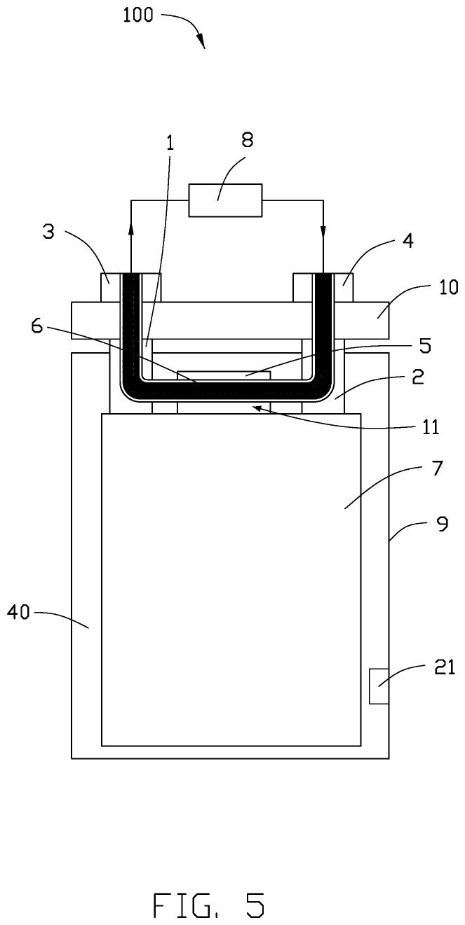

Referring to FIG. 5, in a second embodiment, the positive and negative electrode tabs 1 and 2 are arranged at the same side of the battery 100, the heat conducting and collecting bodies 5 are arranged between the positive and negative electrode plates and overlap with each other to form the heat converging path 11. A fluid-containing pipe 6 is arranged on the heat converging path 11. The fluid-containing pipe 6 enters into the battery 100 through the negative terminal post 4 and leaves the battery 100 through the positive terminal post 3. A hole through which the fluid-containing pipe 6 passes is defined between the positive and negative terminal posts 3 and 4. In another embodiment, the fluid-containing pipe 6 enters into the battery 100 through the positive terminal post 3 and leaves the battery 100 through the negative terminal post 4. A second heat exchange device 8 outside of the metal casing 9 is connected to an inlet and an outlet of the fluid-containing pipe 6, thereby forming a complete path for circulation.

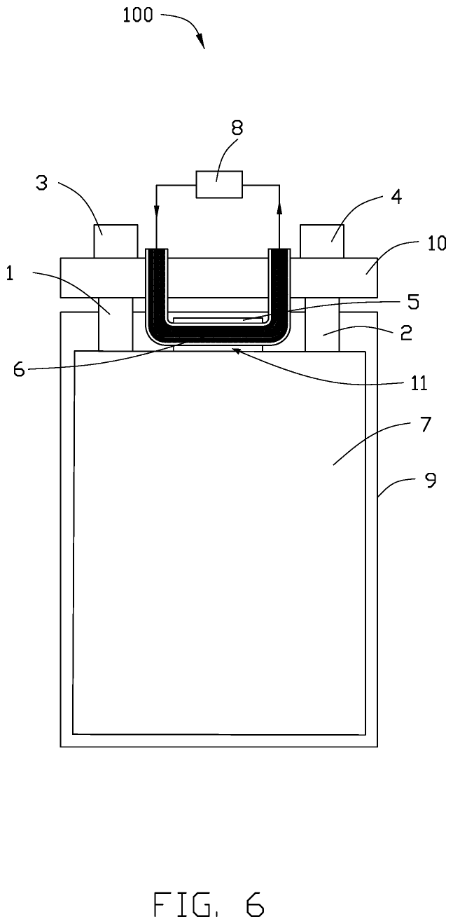

Referring to FIG. 6, in a third embodiment, the positive and negative electrode tabs 1 and 2 are arranged at the same side of the battery 100, the heat conducting and collecting bodies 5 are arranged between the positive and negative electrode plates and overlap with each other to form the heat converging path 11. The fluid-containing pipe 6 is arranged on the heat converging path 11. The fluid-containing pipe 6 enters and leaves the battery 100 through the top cover plate 10 but at different positions thereof. The second heat exchange device 8 outside of the metal casing 9 is connected to an inlet and outlet of the fluid-containing pipe 6 to form a complete circulation path.

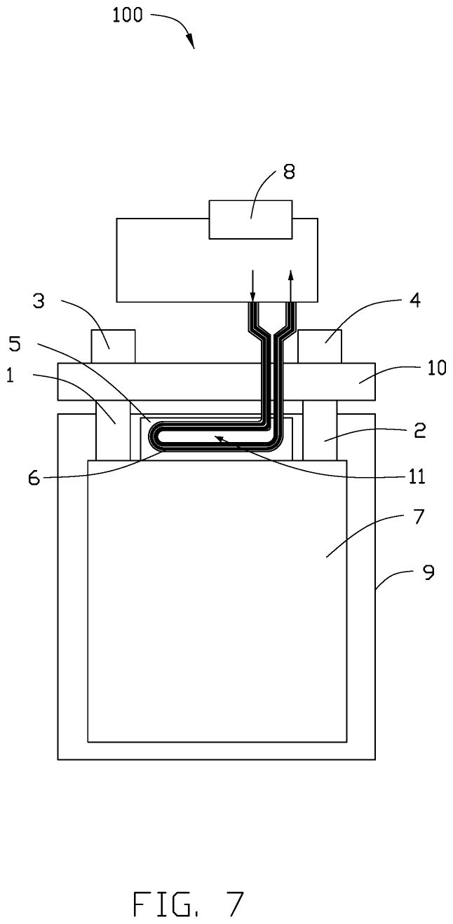

Referring to FIG. 7, in a fourth embodiment, the positive and negative electrode tabs 1 and 2 are arranged at the same side of the battery 100, the heat conducting and collecting bodies 5 are arranged between the positive and negative electrode plates, on the positive electrode plate, or on the negative electrode plate. The heat conducting and collecting bodies 5 overlap with each other to form the heat converging path 11. The fluid-containing pipe 6 is arranged on the heat converging path 11. The top cover plate 10 defines a first hole through which the fluid-containing pipe 6 enters and leaves the battery 100. The inlet and outlet of the fluid-containing pipe 6 are both arranged in the first hole. The second heat exchange device 8 outside of the metal casing 9 is connected to an inlet and outlet of the fluid-containing pipe 6 to form the complete path.

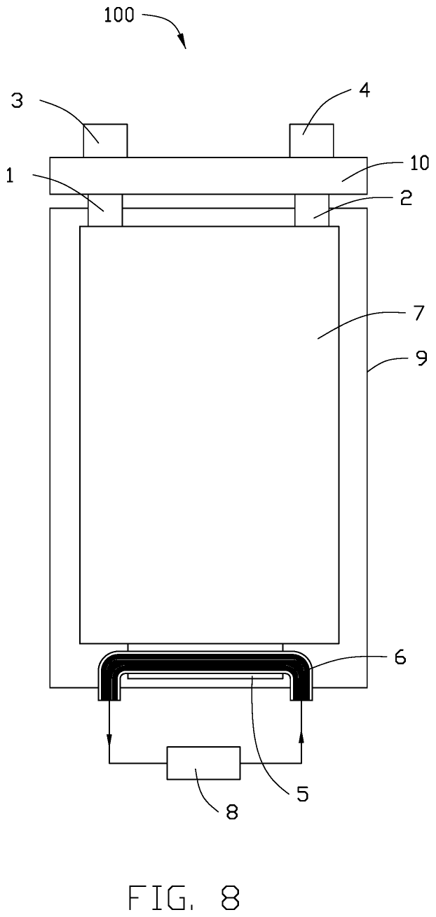

Referring to FIG. 8, in a fifth embodiment, the positive and negative electrode tabs 1 and 2 are arranged at the same side of the battery 100, the heat conducting and collecting bodies 5 are arranged on an opposite side of battery 100 with respect to the positive and negative electrode tabs 1 and 2. The heat conducting and collecting bodies 5 are arranged on the positive electrode plate or the negative electrode plate and overlap with each other to form the heat converging path 11. The fluid-containing pipe 6 enters and leaves the battery 100 through the bottom of the metal casing 9 again at different positions thereof. The second heat exchange device 8 outside of the metal casing 9 is connected to an inlet and outlet of the fluid-containing pipe 6 to form the complete path.

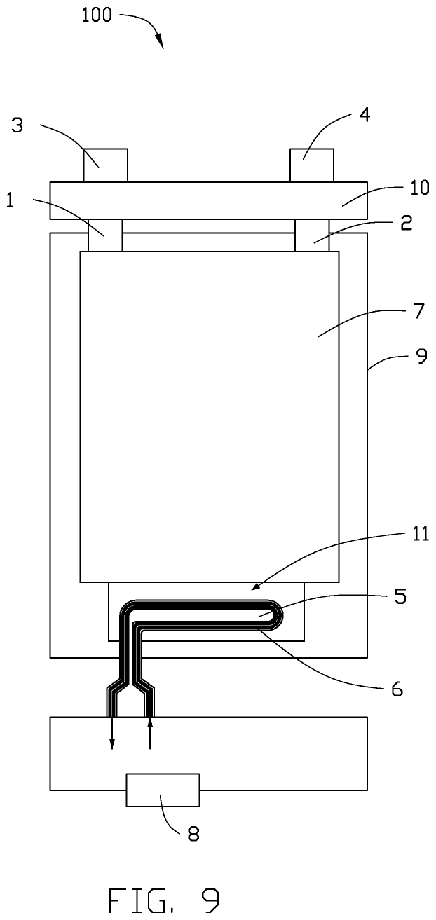

Referring to FIG. 9, in a sixth embodiment, the positive and negative electrode tabs 1 and 2 are arranged at the same side of the battery 100, and the heat conducting and collecting bodies 5 are arranged on an opposite side of battery 100 with respect to the positive and negative electrode tabs 1 and 2. The heat conducting and collecting bodies 5 which are arranged on the positive electrode plate or the negative electrode plate overlap with each other to form the heat converging path 11. The bottom of the metal casing 9 defines a second hole through which the fluid-containing pipe 6 enters and leaves the battery 100. The inlet and outlet of the fluid-containing pipe 6 are both arranged in the second hole. The second heat exchange device 8 outside of the metal casing 9 is connected to an inlet and outlet of the fluid-containing pipe 6 to form the complete path.

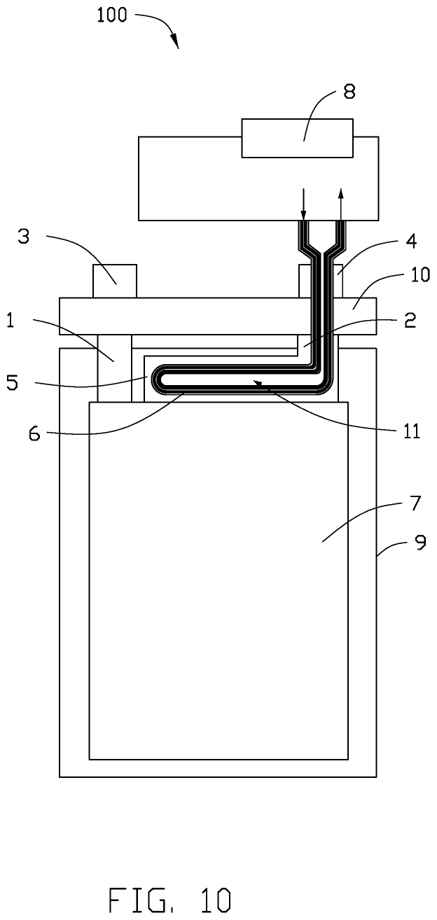

Referring to FIG. 10, in a seventh embodiment, the positive and negative electrode tabs 1 and 2 are arranged at the same side of the battery 100, the heat conducting and collecting bodies 5 are arranged between the positive and negative electrode plates and connected to the negative electrode plate as an integral unit. The heat conducting and collecting bodies 5 overlap with each other to form the heat converging path 11. The fluid-containing pipe 6 is arranged on the heat converging path 11. The fluid-containing pipe 6 enters and leaves the battery through a hole defined on the negative thermal post 4. The hole 60 through which the fluid-containing pipe 6 passes is defined between the positive and negative terminal posts 3 and 4. In another embodiment, the heat conducting and collecting bodies 5 are connected to the positive electrode plate as an integral unit, the fluid-containing pipe 6 enters and leaves the battery through a hole defined on the positive thermal post 3. The second heat exchange device 8 outside of the metal casing 9 is connected to an inlet and outlet of the fluid-containing pipe 6 to form the complete path.

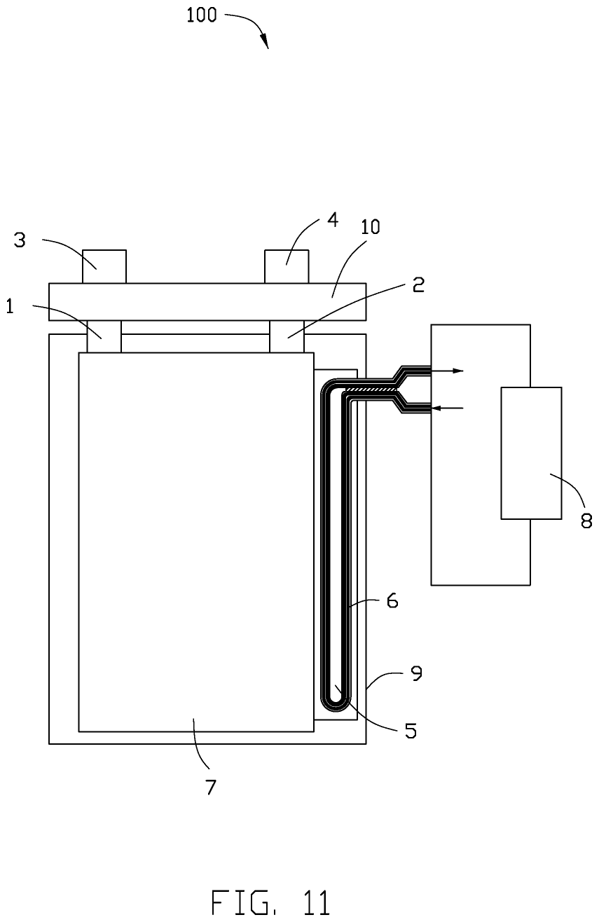

Referring to FIG. 11, in an eighth embodiment, the positive and negative electrode tabs 1 and 2 are arranged at the same side of the battery 100, the heat conducting and collecting bodies 5 are arranged on one side of the battery cell 7 and overlap with each other to form the heat converging path 11. The fluid-containing pipe 6 is arranged on the heat converging path 11. One side of the metal casing 9 defines a third hole through which the fluid-containing pipe 6 enters and leaves the battery 100. The second heat exchange device 8 outside of the metal casing 9 is connected to an inlet and outlet of the fluid-containing pipe 6 to form the complete path.

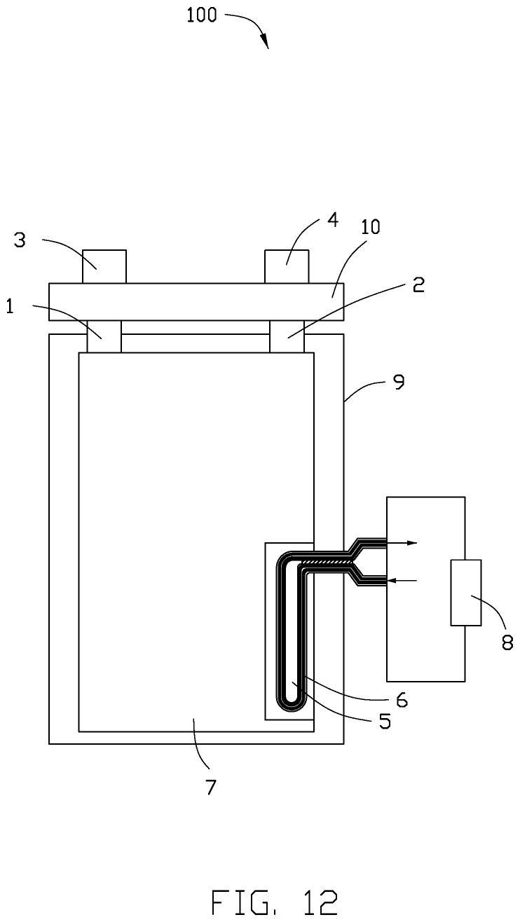

Referring to FIG. 12, in a ninth embodiment, the positive and negative electrode tabs 1 and 2 are arranged at the same side of the battery 100, the heat conducting and collecting bodies 5 are arranged on one side of the battery cell 7, are recessed with respect to the electrode plate, and overlap with each other to form the heat converging path 11. The fluid-containing pipe 6 is arranged on the heat converging path 11. One side of the metal casing 9 defines a fourth hole through which the fluid-containing pipe 6 enters and leaves the battery 100. The second heat exchange device 8 outside of the metal casing 9 is connected to an inlet and outlet of the fluid-containing pipe 6 to form the complete path.

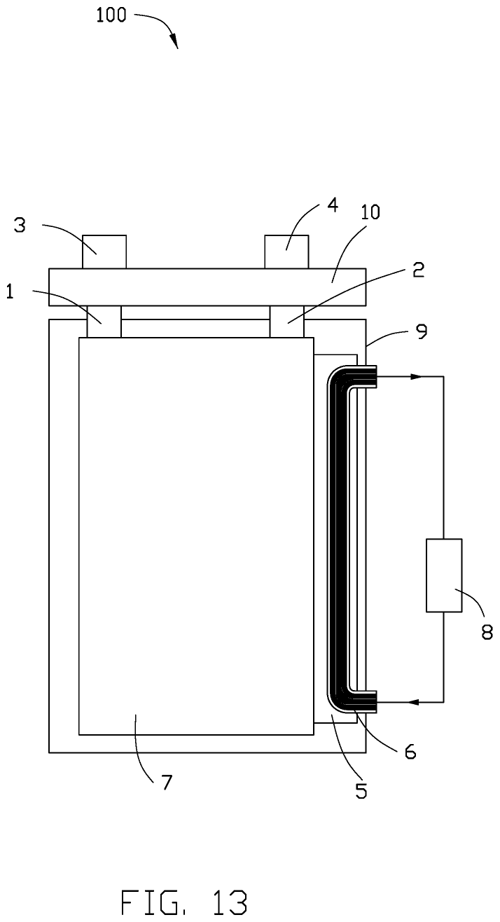

Referring to FIG. 13, in an eleventh embodiment, the positive and negative electrode tabs 1 and 2 are arranged at the same side of the battery 100, the heat conducting and collecting bodies 5 are arranged on one side of the battery cell 7 and overlap with each other to form the heat converging path 11. The fluid-containing pipe 6 is arranged on the heat converging path 11. The fluid-containing pipe 6 enters and leaves the battery 100 through one side of the metal casing 9 at different positions thereof. The second heat exchange device 8 outside of the metal casing 9 is connected to an inlet and outlet of the fluid-containing pipe 6 to form the complete path.

In at least one embodiment, at least a portion of the heat conducting and collecting bodies 5 defines a plurality of holes (not shown). The holes can pass through the heat conducting and collecting body 5, and have a mesh structure or a 3D internal structure. In another embodiment, at least a portion of the heat conducting and collecting bodies 5 can have a concave and/or convex surface. As such, the heat conducting performance of the heat conducting and collecting body 5 is improved.

In at least one embodiment, the heat conducting and collecting body 5 can carry an insulating layer (not shown) on a surface thereof. As such, a short circuit in the battery 100 and concomitant damage are avoided.

In at least one embodiment, when there is more than one heat converging path 11, the heat converging paths 11 can be arranged at a same side of the battery 100, for example, the heat converging paths 11 and the positive and negative electrode tabs 1 and 2 can be arranged on the same side. The heat converging paths 11 can also be arranged at different sides of the battery 100. The heat converging paths 11 arranged at the side of the positive electrode tab 1 can be one or more.

In at least one embodiment, the heat conducting and collecting body 5 can protrude from the positive electrode plate 71, which facilitates the conduction and dissipation of the heat energy and the overlapping of the conducting and collecting body 5. The heat conducting and collecting body 5 protruding from the positive electrode plate 41 is further inserted into the electrolyte 40 received in the metal casing 9. As such, the heat energy from the heat conducting and collecting body 5 can be conducted into the electrolyte 40 and further to the external surface of the battery 100. Therefore, heat energy is not accumulated in the battery 100 due to poor heat conduction of the separator 72. Furthermore, the heat energy in the electrolyte 40 can be quickly moved to the positive and the negative electrode plates 71 and 73, such rapid transfer preventing the temperature of the positive and the negative electrode plates 71 and 73 from being too low.

Referring to FIG. 5, a first heat exchange device 21 is arranged in the electrolyte 40 for heating or cooling the electrolyte 40. The electrolyte 40 can heat or can cool the heat conducting and collecting bodies 5, thereby maintaining the temperature of the battery 100 within a suitable range.

In at least one embodiment, the heat conducting and collecting body 5 can also be recessed with respect to the positive electrode plate 71, which facilitates reduction in weight of the battery 100, and further improves the energy density of the battery 100.

In at least one embodiment, an interconnecting portion (not shown) is formed between the heat conducting and collecting body 5 and the positive electrode plate 71. A width of the heat conducting and collecting body 5 is the same as a width of the interconnecting portion. As such, without increasing the weight of the battery 100, the contact area between the heat conducting and collecting body 5 and the interconnecting portion is maximized and heat conduction effect is optimized.

In at least one embodiment, the positive current collector 711 or the portion which is not coated by the positive active material layer 713 can be parallel to the positive active material layer 713, which simplifies the manufacturing process and improves the manufacturing efficiency.

In at least one embodiment, the portion of the positive current collector 711 not coated by the positive active material layer 713 can be on a central portion of the positive current collector 711.

In at least one embodiment, referring to FIG. 4, a temperature sensor 30 is arranged on the heat converging path 11, which can sense the temperature of the heat converging path 11. The temperature sensor 30 can be a thin-film temperature sensor.

In at least one embodiment, the positive active material of the positive active material layer 713 is lithium iron phosphate, lithium cobalt oxide, lithium manganate, or a ternary material. The negative active material of the negative active material layers 733 is carbon, tin-based negative material, a transition metal nitride containing lithium or alloy.

Implementations of the above disclosure are described by way of embodiments only. It should be noted that devices and structures not described in detail are to be implemented by general equipment and methods available in the art.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A lithium-ion power battery comprising:
a battery cell comprising a positive electrode plate and a negative electrode plate, the positive electrode plate comprising a positive current collector and a positive active material layer coated on the positive current collector, the negative electrode plate comprising a negative current collector and a negative active material layer coated on the negative current collector;
wherein at least one of the positive electrode plate and the negative electrode plate comprises two heat conducting and collecting bodies, each of the heat conducting and collecting bodies is a portion of the positive current collector which is not coated by the positive active material layer or a portion of the negative current collector which is not coated by the negative active material layer, at least two heat conducting and collecting bodies are stacked together to form at least one heat converging path, which is configured to transmit heat energy into or out of the battery cell, an insulating element is connected to the at least one heat converging path.

2. The lithium-ion power battery of claim 1, wherein the at least two heat conducting and collecting bodies are connected by welding.

3. The lithium-ion power battery of claim 2, wherein a method of the welding comprises ultrasonic welding, laser welding, and friction welding.

4. The lithium-ion power battery of claim 1, wherein the at least two heat conducting and collecting bodies are connected to each other by bolting or riveting.

5. The lithium-ion power battery of claim 1, wherein the at least two heat conducting and collecting bodies are bent towards each other.

6. The lithium-ion power battery of claim 5, wherein the at least two heat conducting and collecting bodies is bent to be inclined with the positive electrode plate or the negative electrode plate by an angle between 0 degree to 90 degrees.

7. The lithium-ion power battery of claim 5, wherein the at least two heat conducting and collecting bodies are bent towards different directions or a single direction.

8. The lithium-ion power battery of claim 1, wherein a portion of each of the heat conducting and collecting bodies is bent, and the portion which is bent is connected to a remaining portion of a corresponding one of the at least two heat conducting and collecting bodies, the remaining portion of each of the heat conducting and collecting bodies is straight.

9. The lithium-ion power battery of claim 8, wherein the portion of the heat conducting and collecting bodies are bent towards a single direction or different directions.

10. The lithium-ion power battery of claim 1, wherein at least a portion of the at least two heat conducting and collecting bodies defines a plurality of holes or a concave and convex surface.

11. The lithium-ion power battery of claim 1, wherein an insulating layer is arranged on a surface of each of the heat conducting and collecting bodies or on a surface of each of the at least one heat converging path.

12. The lithium-ion power battery of claim 1, wherein the at least one heat converging path is arranged on an end of the lithium-ion power battery, the end of the lithium-ion power battery having a positive electrode tab, an end of the lithium-ion power battery opposite to the positive electrode tab, or a side of the lithium-ion power battery.

13. The lithium-ion power battery of claim 12, wherein the heat conducting and collecting bodies form a plurality of heat converging paths, at least one of the plurality of heat converging paths is arranged on the end of the lithium-ion power battery having the positive electrode tab.

14. The lithium-ion power battery of claim 1, wherein each of the at least two heat conducting and collecting bodies protrudes from the positive electrode plate.

15. The lithium-ion power battery of claim 14, wherein portions of the at least two heat conducting and collecting bodies which protrude from the positive electrode plate are inserted into an electrolyte of the lithium-ion power battery.

16. The lithium-ion power battery of claim 1, wherein a heat exchange device is disposed in an electrolyte of the lithium-ion power battery, the heat exchange device heats or cools the electrolyte.

17. The lithium-ion power battery of claim 1, wherein each of the at least two heat conducting and collecting bodies is recessed with respect to the positive electrode plate.

18. The lithium-ion power battery of claim 1, wherein an interconnecting portion is formed between the at least two heat conducting and collecting bodies and the positive electrode plate, a width of each of the at least two heat conducting and collecting bodies is the same as a width of the interconnecting portion.

19. The lithium-ion power battery of claim 1, wherein a portion of the positive current collector which is not coated by the positive active material layer is on a central portion of the positive current collector.

20. The lithium-ion power battery of claim 1, wherein a temperature sensor is arranged on the at least one heat converging path.
